(19) United States
(12) Patent Application Publication
(10) Pub. No.: US 2017/0169490 A1
(43) Pub. Date: Jun. 15, 2017

(54) Automated Personalized Product Specification

(71) Applicant: Martin J. Bonacci, Albuquerque, NM (US)

(72) Inventor: Martin J. Bonacci, Albuquerque, NM (US)

(21) Appl. No.: 14/693,620

(22) Filed: Apr. 22, 2015

(51) Int. Cl. G06Q 30/06; G05B 19/27; G05B 19/4097

(52) U.S. Cl. CPC G06Q 30/0621; G05B 19/4097; G05B 19/27; G05B 2219/49023

(57) ABSTRACT

The present invention relates to a automated system to arrive at a detailed personalized specification for products sold using a website or app to calculate the best fitting personalized specifications, and design for the customer based on the opinions of expert designers in a network, then produces those custom products to those customer unique personalized specifications.

### BACKGROUND OF THE INVENTION

### 1. Field of the Invention

The present invention relates to a automated system to arrive at a detailed personalized specification for products sold using a website or app to calculate the best fitting personalized specifications, and design for the customer based on the opinions of expert designers in a network, then produces those custom products to those customer unique personalized specifications.

### 2. Description of the Prior Art

Sporting goods and equipment like snowboards and skis that are made to unique specifications for individual users require lengthy consultations either in person or over the phone with the manufacturer, Sporting persons like skiers and snowboarders that have the financial means to afford a custom made sporting goods like snowboards or skis and the interest in improving their performance and enjoyment by getting equipment that fit their body better than standard stock equipment, rarely have the knowhow to design the best fitting snowboard or skis for themselves. Very few skiers or snowboarders know enough about the designers at custom manufacturing companies to trust that they would design the best skis or snowboard for them. Because of this, most skiers and snowboarders are left choosing between equipment options that not specificity fit to their body and personal preferences and are getting a lower level of performance and enjoyment out of their skis and snowboards.

U.S. Pat. No. 7,658,327 of Tuchman, et al, issued on Feb. 9, 2010, for a virtual retail assistant, discloses a customer care management via a communications systems and methods including, in embodiments, a combination of automated and human services to be provided to a customer in a retail store environment in real time. For example, one embodiment of the present invention provides an automated method for assisting a customer in a retail store comprising: identifying the customer; periodically identifying the customer's position in the store; identifying a product of interest to the customer; and communicating information to the customer via a remote specialized sales agent or other audio, visual and/or computer data relevant to the customer.

This approach is deficient in that it can only identify a product of interest and does not personalize the design and fit of the products for the customer.

U.S. Pat. No. 8,930,370 of Musgrove, et al issued on Jan. 6, 2015 for content aggregation method and apparatus for on-line purchasing system, discloses a method for processing plural product information records from the product information sources into one or more groups based on which product information records are likely to correspond to the same product, correlating a unique product ID corresponding to the product associated with each of said groups to identify the product, comparing each identified product to categories of a taxonomy to determine a category for the identified products in the taxonomy, and determining attributes for each categorized product based on the product information records corresponding to each group, creating product specifications based on the determined attributes and storing the product specification in the corresponding determined categories of the taxonomy.

This approach is deficient in that It does not provide expert specifications that could be used to manufacture a product and it's inflexible in that it does not allow for all of the variables that would be necessary to manufacture a product.

U.S. Pat. No. 8,767,948 of Riahi, et al., issued on Jul. 1, 2014 for a back office services of an intelligent automated agent for a contact center, discloses a back office services of an intelligent automated agent for a contact center is provided. The back office services is configured to run on a processor coupled to a non-transitory storage device. The back office services includes: a customerprofile module configured to access a profile of a customer from a customer profile database stored on the storage device, the profile of the customer including interaction data from interactions involving the customer and the contact center, and analysis results from analyzing the interaction data between the interactions involving the customer and the contact center; and a content analysis module configured to generate new analysis results by performing the analyzing of the interaction data between consecutive interactions of the interactions involving the customer and the contact center, and update the analysis results of the profile of the customer on the storage device to reflect the new analysis results.

This approach is deficient in that It does not provide the wide range of data inputs to manufacture a product from a customer's expressed desires. This product just mainly profiles the customers in consecutive interactions.

U.S. Pat. No. 8,821,305, of Cusey, et al, issued on Sep. 2, 2014, for an apparatus, systems, and methods for gathering and processing biometric and biomechanical data, discloses an apparatus, systems, and methods are provided for measuring and analyzing movements of a body and for communicating information related to such body movements over a network. In certain embodiments, a system gathers biometric and biomechanical data relating to positions, orientations, and movements of various body parts of a user performed during sports activities, physical rehabilitation, or military or law enforcement activities. The biometric and biomechanicaldata can be communicated to a local and/or remote interface, which uses digital performance assessment tools to provide a performance evaluation to the user. The performance evaluation may include a graphical representation (e.g., a video), statistical information, and/or a comparison to another user and/or instructor. In some embodiments, the biometric and biomechanical data is communicated wirelessly to one or more devices including a processor, display, and/or data storage medium for further analysis, archiving, and data mining. In some embodiments, the device includes a cellular telephone.

This approach is deficient in that while it contains specific biometric and biomechanical data, it doesn't use this data along with expressed desires to design a specific specification for a product to be manufactured.

U.S. Pat. No. 6,371,962, of Solheim, et al, issued on Feb. 12, 2013, describes Methods apparatus, and systems to custom fit golf clubs. In one example, a method can comprise (i) receiving, at a processing device, physical characteristic information, performance characteristic information, and shot characteristic information associated with an individual, (ii) calculating, with a component option analyzer of the processing device, a first optimal component of a plurality of components for an optimized golf club for the individual based on at least one of the physical characteristic information, the performance characteristic information, or the shot characteristic information associated with the individual; and (iii) calculating, with the component option analyzer of the processing device, a second optimal component of the plurality of components based on the first optimal component. The processing device may calculate the first optimal option and the second optimal option via the component option analyzer.

This method is limited by not taking into consideration that one expert in the activity may define “optimal” differently from another expert. There is no option to choose who's expert opinion to base the fit of the equipment on. The end user has to trust the “option analyzer” rather than an expert that they may already know and trust.

U.S. Pat. No. 8,994,826, of Bentley, issued on Mar. 31, 2015, describes a Portable wireless mobile device motion capture and analysis system and method configured to display motion capture/analysis data on a mobile device. System obtains data from motion capture elements and analyzes the data. Enables unique displays associated with the user, such as 3D overlays onto images of the user to visually depict the captured motion data. Ratings associated with the captured motion can also be displayed. Predicted ball flight path data can be calculated and displayed. Data shown on a time line can also be displayed to show the relative peaks of velocity for various parts of the user's body. Based on the display of data, the user can determine the equipment that fits the best and immediately purchase the equipment, via the mobile device. Custom equipment may be ordered through an interface on the mobile device from a vendor that can assemble-to-order customer built equipment and ship the equipment.

This system is limited in that the equipment option is based solely on a computer's recommendation when many experts may have many different opinions about which equipment would be best and this does not include the desires of the customer in providing a specification for a product to be manufactured.

U.S. Pat. No. 8,926,454, of Solheim, et al, issued on Jan. 6, 2015, describes Fitting systems for golf equipment using camera image for measurement of individual, and related methods. In one example, a system for fitting golf equipment for an individual can be configured to be used with an electronic device comprising a fitting processor module and a camera. The system can comprise an image analysis module configured to receive image data of at least a portion of the individual and one or more physical indicia proximate to the individual, where the image data can be captured by the camera. The image analysis module can also be configured to recognize one or more reference features of the individual from the image data, and to calculate one or more fitting dimensions between the one or more reference features in the image data,

This system is limited in that it does not provide a recommended specification for manufacturing.

### SUMMARY OF THE INVENTION

The present invention relates to a process and apparatus which sells personalized Equipment using a website or app to calculate the best fitting specifications, and design it for the customer based on the opinions of designers in a network, then produces those custom equipment to those customer unique specifications.

It is therefore a primary object of the of the present invention to enable the customer to answer minimal questions on a website or app, receive a personalized specification recommendation and be able to purchase the product without human consultation.

It is another object of the present invention to have multiple design algorithms, each based on an experts opinions enabling the customer to get a product personalized for them by a design calculator based on what the expert of their choice would recommend for the customer's body.

It is a further object of the present invention to automate the selection and addition of expert designers into the network that the customers can choose from to virtually design their skis or snowboard. Since each expert designer has their own opinions about fitting equipment, each expert's design algorithm will be unique, thus requiring an efficient system for cataloging and calculating each expert's design algorithm.

It is a further object of the present invention to automate production design with software that generates tool path files for manufacturing the equipment by morphing the shape of the equipment to match specifications provided by the personalized design without using 3d modeling or cad.

### DETAILED DESCRIPTION OF THE INVENTION

### 1. Definitions

Equipment refers to equipment that is fit the user's body to maximize performance such as sporting equipment like snowboards, skis and golf equipment.

An “expert” or “expert designer” is someone who has extensive experience using the equipment such as an instructor or professional.

A “user” or “customer” is someone with less experience in the use of the equipment than the expert such as a student.

### 2. Best Mode of the Invention

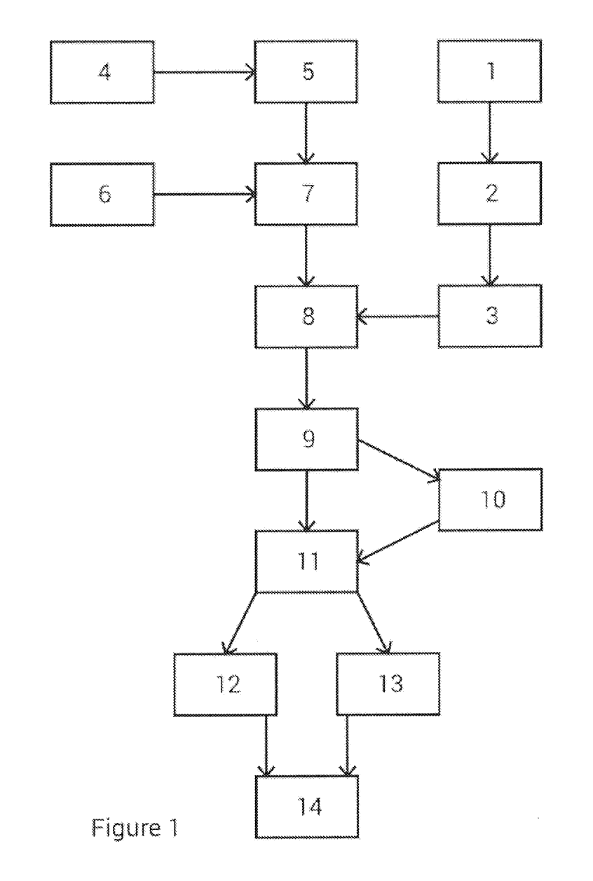

FIG. 1 shows a flowchart of the best mode contemplated by the inventor of the automated personalized product specification system according to the concepts of the present invention.

### 3. How to Make the Invention

Provide an automated personalized product design specification system for equipment, including an input system for the customer, a database of expertise and recommendation from experts that can be used to help complete personalized product design specification, a system for calculating personalized recommended equipment design specifications, an interface for capturing an order based on the personalized product design specification, and system to output the personalized design specification and input it into a manufacturing process to produce the product. This is explained in more detail below.

Provide an Internet community that enables its members to be expert equipment designers by creating a personalized design tool, for each member of the community that can design equipment to fit the user the way the expert would want equipment to fit if the expert was the user and had the user's ability level, the user's intended use of the equipment and the user's personal preferences.

In FIG. 1 Box 1 create a method for a new expert designer to enter their body dimensions, intended uses of the equipment and personal preferences. Data can be entered manually, by photographing or video recording the expert's body, by scanning the expert's body or by recording the expert's body movements. Also record the new expert designer's preferred equipment specifications.

Provide a system that allows for the automated growth of a community of equipment design consultants by using the designer's dimensions, personal equipment preferences, types of expertise, and specific equipment dimensions to generate a set of unique design equations for each expert designer's automated design tool.

In FIG. 1 Box 2 analyze the relationships between the expert's preferred equipment specifications and the expert's body dimensions, intended equipment uses, ability level and personal preferences. Then generate a set of design equations unique to the expert, that will be used to calculate what equipment the expert would use if the expert had the user's body, intended equipment uses, personal preferences, and ability level.

In FIG. 1 Box 3 store the unique expert's design equations in a database for use in designing equipment for users.

Once a group of expert designers has been entered into the system, the customer can use the expert designers' design algorithm to design personalized equipment for the customer based on what the design expert would prefer to use if the expert designer was the customer, with the customer's dimensions, ability level, intended uses for the equipment and personal preferences.

Provide a system that enables the user to choose between multiple expert designers' virtual design tools to have equipment designed for them with unique specifications as the designer would design for themselves if they had the user's dimensions and needs of the user.

Provide a system that designs equipment for the user based on what an expert design specialist, which could be chosen by the user from a group of design specialists, would choose for themself if the expert design specialist had the user's body dimensions, the user's intended use, and the user's personal preferences and allows the user to order the equipment design,

In FIG. 1 Box 5 provide a way for the customer to choose an expert designer that the user would like to design your equipment such as a webpage or app.

Provide a website or app that designs custom equipment specification for the user by obtaining input data based on the user's input data, the intended use, ability level, and on their personal preferences; and produces a product specification allowing the user to order the product specification designed for them with unique personalized specifications on the website.

In FIG. 1 Box 7 provide individual expert equipment designer's pages that allow the user to enter their body dimensions, intended uses of the equipment, ability level and personal preferences. Data can be entered manually, by photographing the user's body, by scanning the user's body or by recording the user's body movements.

In FIG. 1 Box 8 calculate the personalized design for the user based on what the expert designer would design for themselves if the expert designer had the body, ability level and personal preferences of the user and intended on using the equipment for the same purpose.

In FIG. 1 Box 9 present the user with the recommended equipment design based on what the expert would choose if the expert was the user and then give the option to select features, colors and select or upload a graphic and purchase the equipment.

In FIG. 1 Box 10 provide a method for the user to click a link that will post options and a request for their friend's to give their opinion on the options, to the user's social network, the friend's responses will be pulled from the social network, and displayed to the user to help them choose, if the user needs help choosing an option such as colors and features.

In FIG. 1 Box 11 provide a system that offers customers custom color and pattern clothing and accessories to match custom made equipment. Provide a method for the customer to complete the purchase and checkout.

In FIG. 1 Box 12 provide software usable by a laymen that generates tool path files for manufacturing the equipment by morphing the shape of the equipment to match specifications provided by the personalized design without using 3d modeling or cad.

In FIG. 1 Box 13 provide software usable by a laymen that generates 3d printing files for manufacturing the equipment by morphing the shape of the equipment to match specifications provided by the personalized design without using 3d modeling or cad.

In FIG. 1 Box 14 produce the equipment to the customer's unique specifications and deliver it to the customer.

### 4. How to Use the Invention

The steps in using an automated personalized product design specification system include, collecting data from the user of physical dimensions, desires, and ability level; allowing the user to select an industry expert to base their design on; software to combine the user inputs and selected expert data to arrive at a personalized product design specification; and sending the resulting product design specification to the manufacturing facility to manufacture the product from the produced product design specification. This is explained in more detail below.

In FIG. 1 Box 4 the customer arrives at the main designer network page.

in FIG. 1 Box 5 at the expert designer selection page a user chooses an expert in the field to be the expert designer who their personalized design is based on.

In FIG. 1 Box 6 the user could also be referred directly to a specific expert designer's page

In FIG. 1 Box 7 the user enters their physical dimensions, intended uses of the equipment, ability level and desires. Data can be entered manually, by photographing the user's body, by scanning the user's body or by recording the user's body movements.

In FIG. 1 Box 8 a personalized design is calculated for the user based on what the expert designer would design for themselves if they were the user, and had the ability level and personal preferences of the user and intended on using the equipment for the same purpose. Software combines the user inputs and selected expert data to arrive at a personalized product design specification.

In FIG. 1 Box 9 (expert designer's recommendation page) The user is presented with the recommended equipment design based on what the expert would choose if the expert was the user and then given the option to select features, colors and select a graphic and purchase the equipment.

In FIG. 1 Box 10 if the user needs help choosing an option such as colors and features, they can click a link that will post the options and a request for their friend's to give their opinion on the options, to the user's social networks Their friend's responses will be pulled from the social network and displayed to the user to help them choose.

In FIG. 1 Box 11 the customer chooses to make the purchase and checkout.

In FIG. 1 Box 14 send the resulting product design specification to the manufacturing facility to manufacture the product from the produced product design specification. The equipment is then produced to the customer's unique specifications and shipped to the customer or picked up at a local 3d printing station.

What is claimed is:

1. An automated personalized product design specification system for equipment, comprising: an input system for the customer; a database of expertise and recommendation from experts that can be used to help complete personalized product design specification; a system for calculating personalized recommended equipment design specifications; an interface for capturing an order based on the personalized product design specification; and system to output the personalized design specification and input it into a manufacturing process to produce the product.

2. An automated personalized product design specification system, according to claim 1, further comprising: a website that designs custom equipment specification for the user; input data based on the user's input data, the intended use, ability level, and on their personal preferences; and produces a product specification allowing the user to order the product specification designed for them with unique personalized specifications on the website.

3. An automated personalized product design specification system, according to claim 1, further comprising an app that designs custom equipment specification for the user; input data based on the user's input data, the intended use, ability level, and on their personal preferences; and produces a product specification allowing the user to order the product specification designed for them with unique personalized specifications on the app.

4. An automated personalized product design specification system, according to claim 1, further comprising:a system that designs equipment for the user based on what an expert design specialist, which could be chosen by the user from a group of design specialists, would choose for themself if the expert design specialist had the user's body dimensions, the user's intended use, and on the user's personal preferences and allows the user to order the equipment designed for then with unique specifications.

5. An automated personalized product design specification system, according to claim 1, further comprising: a system that enables the user to choose between multiple expert designers' virtual design tools to have equipment designed for them with unique specifications as the designer would design for themselves if they had the user's dimensions and needs of the user.

6. An automated personalized product design specification system, according to claim 1, further comprising: An Internet community that enables its members to be expert equipment designers by creating a personalized design tool, for each member of the community that can design equipment to fit the user the way the expert would want equipment to fit if the expert was the user and had the user's ability level, the user's intended use of the equipment and the user's personal preferences.

7. An automated personalized product design specification system, according to claim 1, further comprising: A system that allows for the automated growth of a community of equipment design consultants by using the designer's dimensions, personal equipment preferences, types of expertise, and specific equipment dimensions to generate a set of unique design equations for each expert designer's automated design tool.

8. An automated personalized product design specification system, according to claim 1, further comprising: a snowboard design software that enables a laymen to enter the dimensions of a snowboard and will generate designs and cnc toolpath files generating shapes that are morphed so that the general shape within a wide variety of sizes and aspect ratios look similar.

9. An automated personalized product design specification system, according to claim 1, further comprising: a ski design software that enables a laymen to enter the dimensions of a ski and will generate designs and cnc toolpath files generating shapes that are morphed so that the general shape within a wide variety of sizes and aspect ratios look similar.

10. An automated personalized product design specification system, according to claim 1, further comprising: a method for the user to click a link that will post options and a request for their friend's to give their opinion on the options, to the user's social network, the friend's responses will be pulled from the social network, and displayed to the user to help them choose, if the user needs help choosing an option such as colors and features.

11. An automated personalized product design specification system, according to claim 1, further comprising: a system that offers customers custom color and pattern clothing and accessories to match custom made equipment.

12. An automated personalized product design specification system, according to claim 1, further comprising: equipment including snowboard equipment.

13. An automated personalized product design specification system, according to claim 1, further comprising: equipment including ski equipment.

14. An automated personalized product design specification system, according to claim 1, further comprising: equipment including golf equipment.

15. An automated personalized product design specification system, according to claim 1, further comprising: equipment including equipment which can perform better if fitted to the user.

16. A method for assembling an automated personalized product design specification comprising the steps of: collecting data from the user of physical dimensions, desires, ability level; allowing the user to select industry expertise to be included in the design; software to combine the user inputs and selected expert data to arrive at a personalized product design specification; and sending the resulting product design specification to the manufacturing facility to manufacture the product from the produced product design specification.

17. A method for assembling an automated personalized product design specification according to claim 16, wherein a user chooses an expert in the field to be the expert designer who their personalized design is based on.

18. A method for assembling an automated personalized product design specification according to claim 16, wherein the user enters their body dimensions, intended uses of the equipment, ability level and personal preferences.

19. A method for assembling an automated personalized product design specification according to claim 16, wherein a personalized design is calculated for the user based on what the expert designer would design for themselves if they were the user, and had the ability level and personal preferences of the user and intended on using the equipment for the same purpose.

20. A method for assembling an automated personalized product design specification according to claim 16, wherein the user is presented with the recommended equipment design based on what the expert would choose if the expert was the user, then given the option to select features, colors, select a graphic, and purchase the equipment.

21. A method for assembling an automated personalized product design specification according to claim 16, wherein if the user needs help choosing an option such as colors and features, they can click a link that will post the options and a request for their friend's to give their opinion on the options, to the user's social networks, the friend's responses will be pulled from the social network, and displayed to the user to help them choose.

22. A method for assembling an automated personalized product design specification according to claim 16, wherein the customer chooses to make the purchase and checkout.

23. A method for assembling an automated personalized product design specification according to claim 16, wherein the equipment is then produced to the customer's unique specifications,

24. A method for assembling an automated personalized product design specification according to claim 16, wherein the equipment is then 3d printed to the customer's unique specifications.

25. A method for assembling an automated personalized product design specification according to claim 16, wherein data can be entered by photographing the user's body.

26. A method for assembling an automated personalized product design specification according to claim 16, wherein data can be entered by scanning the user's body.

27. A method for assembling an automated personalized product design specification according to claim 16, wherein data can be entered by recording the user's body movements.
